(19) United States
(12) Patent Application Publication
(10) Pub. No.: US 2022/0170593 A1
(43) Pub. Date: Jun. 2, 2022

(54) Pressure Vessel and Method of Manufacturing Same

(71) Applicants: Hyundai Motor Company, Seoul (KR); Kia Corporation, Seoul (KR)

(72) Inventor: Dong Sun Lee, Hwaseong-si (KR)

(21) Appl. No.: 17/375,205

(22) Filed: Jul. 14, 2021

(30) Foreign Application Priority Data
Dec. 1, 2020 (KR) 10-2020-0165630

(51) Int. Cl. F17C 1/02

(52) U.S. Cl. CPC F17C 1/02; F17C 2221/012; F17C 2203/0604; F17C 2209/2154; F17C 2201/0109; F17C 2201/0123; F17C 2203/067; F17C 2203/0621

(57) ABSTRACT

An embodiment pressure vessel includes a liner including a cylinder part and dome-shaped side parts at both ends of the cylinder part, and a carbon fiber layer including a first hoop layer surrounding a part of an outer circumferential surface of the cylinder part, and second hoop layers surrounding remaining parts of the outer circumferential surface of the cylinder part, each of the second hoop layers having a thickness that gradually decreases in a direction from the cylinder part to a respective one of the side parts.

### CROSS-REFERENCE TO RELATED APPLICATIONS

This application claims the benefit of Korean Patent Application No. 10-2020-0165630, filed on Dec. 1, 2020, which application is hereby incorporated herein by reference.

### TECHNICAL FIELD

The present disclosure relates to a pressure vessel and a method of manufacturing the same.

### BACKGROUND

A hydrogen vehicle is configured to produce its own electricity by means of a chemical reaction between hydrogen and oxygen and to travel by operating a motor. More specifically, the hydrogen vehicle includes a hydrogen tank (H₂ tank) configured to store hydrogen (H₂), a fuel cell stack configured to produce electricity by means of an oxidation-reduction reaction between hydrogen and oxygen (O₂), various types of devices configured to discharge produced water, a battery configured to store the electricity produced by the fuel cell stack, a controller configured to convert and control the produced electricity, and a motor configured to generate driving power.

A TYPE 4 pressure vessel may be used as the hydrogen tank of the hydrogen vehicle. The TYPE 4 pressure vessel includes a liner (e.g., a nonmetallic material), and a carbon fiber layer formed by winding a carbon fiber composite material around an outer surface of the liner.

Meanwhile, the carbon fiber composite material is lightweight and excellent in strength and elasticity but is very expensive (for example, about 20 or more times more expensive than typical carbon steel having the same weight). Therefore, it is necessary to minimize the amount of use of the carbon fiber composite material in order to reduce manufacturing costs for the pressure vessel.

However, if the amount of use of the carbon fiber composite material, which is used to form the carbon fiber layer of the pressure vessel, is decreased (for example, if a thickness of the carbon fiber layer is decreased) by a predetermined amount or more, there is a problem in that it is difficult to ensure sufficient structural rigidity of the pressure vessel (particularly, structural rigidity against hoop stress applied in a circumferential direction to a cylinder part of the pressure vessel), and stability and reliability deteriorate.

Therefore, recently, various studies have been conducted to ensure structural rigidity and minimize the amount of use of the carbon fiber composite material, but the study result is still insufficient. Accordingly, there is a need for development of a technology for ensuring structural rigidity and minimizing the amount of use of the carbon fiber composite material.

### SUMMARY

The present disclosure relates to a pressure vessel and a method of manufacturing the same. Particular embodiments relate to a pressure vessel with ensured structural rigidity and improved stability and reliability, and a method of manufacturing the same.

Embodiments of the present disclosure provide a pressure vessel with ensured structural rigidity and improved stability and reliability, and a method of manufacturing the pressure vessel.

Embodiments of the present disclosure can ensure structural rigidity of a pressure vessel and minimize the amount of use of a carbon fiber composite material.

Embodiments of the present disclosure can improve efficiency of a pressure vessel, reduce a weight of the pressure vessel, and reduce manufacturing costs.

Embodiments of the present disclosure may simplify a manufacturing process and improve manufacturing efficiency.

Objects to be achieved by the embodiments are not limited to the above-mentioned objects, but also include objects or effects that may be recognized from the solutions or the embodiments described below.

In one embodiment, the present disclosure provides a pressure vessel including a liner including a cylinder part, and dome-shaped side parts provided at both ends of the cylinder part, and a carbon fiber layer including a first hoop layer provided to surround a part of an outer circumferential surface of the cylinder part, and second hoop layers provided to surround the other parts of the outer circumferential surface of the cylinder part and each having a thickness that gradually decreases in a direction from the cylinder part to the side part.

This is to ensure structural rigidity of the pressure vessel and minimize the amount of use of a carbon fiber composite material.

That is, the carbon fiber composite material is lightweight and excellent in strength and elasticity but is very expensive. Therefore, it is necessary to minimize the amount of use of the carbon fiber composite material in order to reduce manufacturing costs for the pressure vessel.

However, if the amount of use of the carbon fiber composite material, which is used to form the carbon fiber layer of the pressure vessel, is decreased (for example, if a thickness of the carbon fiber layer is decreased) by a predetermined amount or more, there is a problem in that it is difficult to ensure sufficient structural rigidity of the pressure vessel (particularly, structural rigidity against hoop stress applied in a circumferential direction to a cylinder part of the pressure vessel), and stability and reliability deteriorate.

In contrast, according to embodiments of the present disclosure, since the thickness of the second hoop layer constituting the carbon fiber layer gradually decreases, it is possible to obtain an advantageous effect of ensuring structural rigidity of the pressure vessel and reducing the amount of use of the carbon fiber composite material.

Above all, according to embodiments of the present disclosure, the carbon fiber layer is configured by using the first hoop layer and the second hoop layers each having the thickness that gradually decreases in the direction from the cylinder part to the side part, and as a result, it is possible to obtain an advantageous effect of ensuring sufficient structural rigidity, which resists hoop stress applied in a circumferential direction to the cylinder part of the pressure vessel, and reducing the amount of use of the carbon fiber composite material.

According to embodiments of the present disclosure, the pressure vessel may include a first helical layer provided to surround an outer surface of the liner.

In particular, the first helical layer may be provided to have a thickness equal to or smaller than 5% of a whole thickness of the carbon fiber layer in order to ensure structural rigidity implemented by the first helical layer and minimize an increase in thickness and weight of the pressure vessel.

According to embodiments of the present disclosure, the first hoop layer may be provided to surround a central region of the cylinder part, and the second hoop layers may be provided to surround two edge regions of the cylinder part with the first hoop layer interposed therebetween.

In particular, a center of the first hoop layer may correspond to a center of the cylinder part, a length of the first hoop layer may be 40% to 60% of a length of the cylinder part, and a length of the second hoop layer may be 20% to 30% of a length of the cylinder part.

More particularly, the thickness of the second hoop layer may linearly decrease in the direction from the cylinder part to the side part.

According to embodiments of the present disclosure, the second hoop layer is provided to have a right-angled triangular cross section having a height corresponding to the thickness of the first hoop layer, and an angle between a hypotenuse and a base line of the right-angled triangular cross section may satisfy the following equation: tan θ=H/L2, where H is the height of the right-angled triangular cross section, and L2 is the length of the second hoop layer corresponding to the base line of the right-angled triangular cross section.

This is derived from the fact that the hoop stress applied to the central region of the cylinder part (the section in which the first hoop layer is formed) is highest and the hoop stress applied to the two edge regions of the cylinder part (the sections in which the second hoop layers are formed) is gradually decreased as the distance from the side part is decreased.

In embodiments of the present disclosure as described above, the thickness of the first hoop layer, which is formed in the section to which the relatively high hoop stress is applied (in the central region of the cylinder part where the hoop stress is concentrated), is large, whereas the thickness of the second hoop layer, which is formed in the section to which the relatively low hoop stress is applied (in the edge region of the cylinder part), is gradually decreased as the distance from the side part is decreased. As a result, it is possible to ensure sufficient structural rigidity against the hoop stress applied to the cylinder part, and it is possible to reduce the amount of use of the carbon fiber composite material, which is used to form the second hoop layer, to the extent that the thickness of the second hoop layer is reduced. As a result, it is possible to obtain an advantageous effect of reducing a weight of the pressure vessel and reducing manufacturing costs.

In addition, according to embodiments of the present disclosure, the thickness of the first hoop layer formed in the section to which the relatively high hoop stress is applied is large, whereas the thickness of the second hoop layer formed in the section to which the relatively low hoop stress is applied is gradually decreased as the distance from the side part is decreased, such that the deviation of the stress applied to the cylinder part may be reduced (the stress may be made more uniform). As a result, it is possible to obtain an advantageous effect of reducing stress to be applied to a weak section (e.g., the central region) of the cylinder part and further improving the margin of safety.

According to embodiments of the present disclosure, the pressure vessel may include a second helical layer provided to surround an outer surface of the first hoop layer, outer surfaces of the second hoop layers, and outer surfaces of the side parts.

According to embodiments of the present disclosure, the pressure vessel may include a third hoop layer formed to cover an outer surface of the second helical layer.

In particular, the third hoop layer may be provided to have a second thickness smaller than the first thickness of the first hoop layer.

For example, the first hoop layer may be provided to have a thickness equal to or larger than 90% of a preset reference hoop layer thickness.

As another example, the third hoop layer may be provided to have a thickness less than 10% of the preset reference hoop layer thickness.

In another embodiment, the present disclosure provides a method of manufacturing a pressure vessel, the method including a preparation step of providing a liner including a cylinder part, and dome-shaped side parts provided at both ends of the cylinder part, a first hoop layer forming step of forming a first hoop layer that surrounds a part of an outer circumferential surface of the cylinder part, and a second hoop layer forming step of forming second hoop layers that surround the other parts of the outer circumferential surface of the cylinder part and each have a thickness that gradually decreases in a direction from the cylinder part to the side part.

According to embodiments of the present disclosure, the first hoop layer may be provided to surround a central region of the cylinder part in the first hoop layer forming step, and the second hoop layers may be provided to surround two edge regions of the cylinder part with the first hoop layer interposed therebetween in the second hoop layer forming step.

In particular, a center of the first hoop layer may correspond to a center of the cylinder part, a length of the first hoop layer may be 40% to 60% of a length of the cylinder part, and a length of the second hoop layer may be 20% to 30% of a length of the cylinder part.

More particularly, the second hoop layer is provided to have a right-angled triangular cross section having a height H corresponding to a thickness of the first hoop layer, and an angle θ between a hypotenuse and a base line of the right-angled triangular cross section satisfies the following equation tan θ=H/L2, where H is the height of the right-angled triangular cross section, and L2 is the length of the second hoop layer corresponding to the base line of the right-angled triangular cross section.

According to embodiments of the present disclosure, the method of manufacturing the pressure vessel may include a first helical layer forming step of forming a first helical layer that surrounds an outer surface of the liner, in which the first hoop layer and the second hoop layer are provided on an outer surface of the first helical layer.

According to embodiments of the present disclosure, the method of manufacturing the pressure vessel may include a second helical layer forming step of forming a second helical layer that surrounds outer surfaces of the second hoop layers and outer surfaces of the side parts.

According to embodiments of the present disclosure, the method of manufacturing the pressure vessel may include a third hoop layer forming step of forming a third hoop layer that covers an outer surface of the second helical layer.

In particular, the third hoop layer may be provided to have a smaller thickness than the first hoop layer, the first hoop layer may be provided to have a thickness equal to or larger than 90% of a preset reference hoop layer thickness, and the third hoop layer may be provided to have a thickness less than 10% of the preset reference hoop layer thickness.

According to embodiments of the present disclosure as described above, it is possible to obtain an advantageous effect of ensuring structural rigidity and improving stability and reliability.

In particular, according to embodiments of the present disclosure, it is possible to obtain an advantageous effect of ensuring structural rigidity of the pressure vessel and minimizing the amount of use of the carbon fiber composite material.

In addition, according to embodiments of the present disclosure, it is possible to obtain an advantageous effect of improving efficiency of the pressure vessel, reducing a weight of the pressure vessel, and reducing manufacturing costs.

In addition, according to embodiments of the present disclosure, it is possible to obtain an advantageous effect of simplifying a manufacturing process and improving manufacturing efficiency.

### BRIEF DESCRIPTION OF THE DRAWINGS

FIG. 1 is a flowchart for explaining a method of manufacturing a pressure vessel according to an embodiment of the present disclosure.

FIG. 2 is a top plan view for explaining a first hoop layer and a second hoop layer related to the method of manufacturing the pressure vessel according to an embodiment of the present disclosure.

FIG. 3 is a cross-sectional view for explaining the first hoop layer and the second hoop layer related to the method of manufacturing the pressure vessel according to an embodiment of the present disclosure.

FIG. 4 is a cross-sectional view for explaining a second helical layer and a third hoop layer related to the method of manufacturing the pressure vessel according to an embodiment of the present disclosure.

FIG. 5 is a cross-sectional view for explaining a first helical layer related to the method of manufacturing the pressure vessel according to an embodiment of the present disclosure.

FIG. 6 is a view for explaining a step of forming the first hoop layer and the second hoop layer according to the method of manufacturing the pressure vessel according to an embodiment of the present disclosure.

FIG. 7 is a view for explaining stress applied to a cylinder part of the pressure vessel according to an embodiment of the present disclosure.

FIG. 8 is a view for explaining efficiency of the pressure vessel according to an embodiment of the present disclosure.

FIG. 9 is a view for explaining an example in which carbon fiber layers are laminated on the pressure vessel according to an embodiment of the present disclosure.

### DETAILED DESCRIPTION OF ILLUSTRATIVE EMBODIMENTS

Hereinafter, embodiments of the present disclosure will be described in detail with reference to the accompanying drawings.

However, the technical spirit of the present disclosure is not limited to the embodiments described herein but may be implemented in various different forms. One or more of the constituent elements in the embodiments may be selectively combined and substituted within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

Unless particularly stated otherwise in the context of the present specification, a singular form may also include a plural form. The explanation “at least one (or one or more) of A, B, and C” described herein may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element can be connected, coupled, or attached directly to another constituent element or connected, coupled, or attached to another constituent element through still another constituent element interposed therebetween.

In addition, the explanation “one constituent element is formed or disposed above (on) or below (under) another constituent element” includes not only a case in which the two constituent elements are in direct contact with each other, but also a case in which one or more additional constituent elements are formed or disposed between the two constituent elements. In addition, the expression “above (on) or below (under)” may include a meaning of a downward direction as well as an upward direction based on one constituent element.

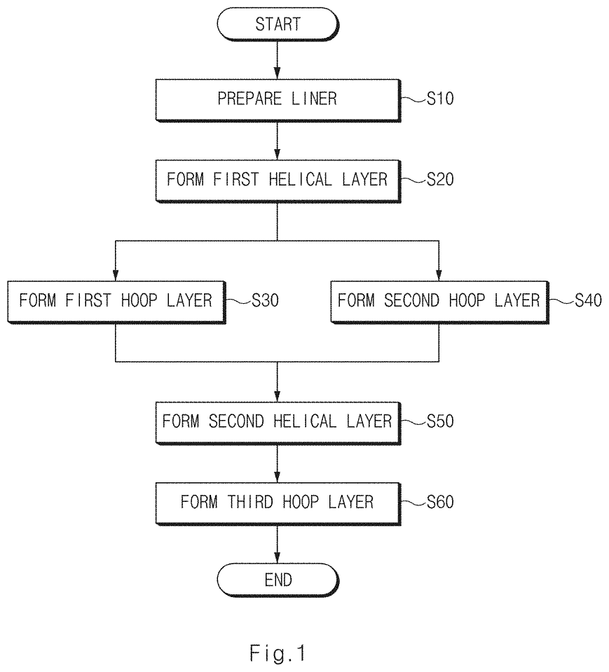

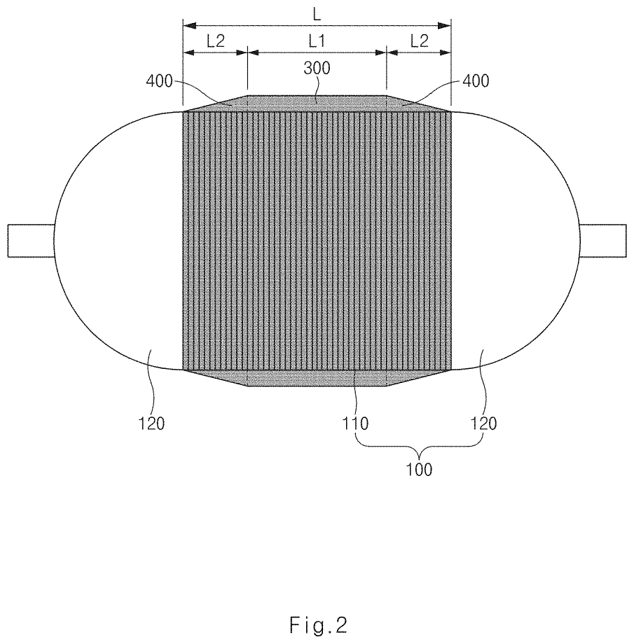

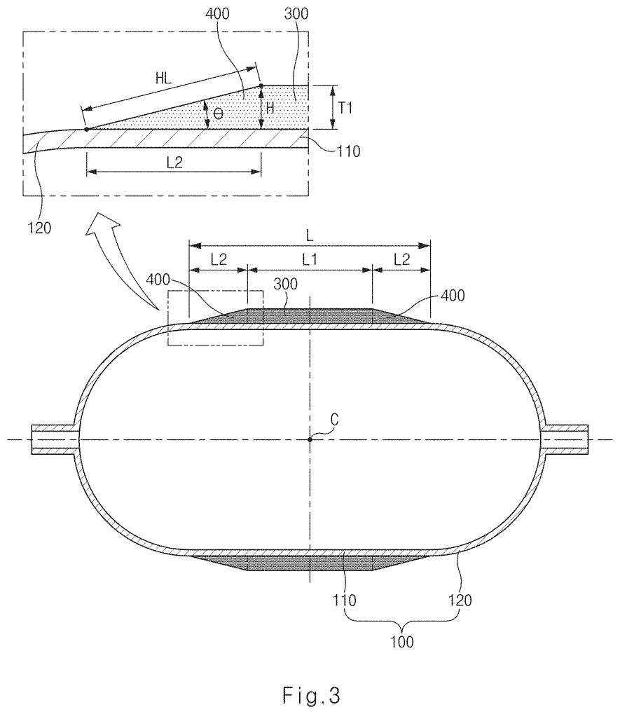

Referring to FIGS. 1 to 8, a method of manufacturing a pressure vessel according to an embodiment of the present disclosure includes a preparation step S10 of providing a liner 100 including a cylinder part 110 and side parts 120 provided at both ends of the cylinder part 110 and each having a dome shape; a first hoop layer forming step S30 of forming a first hoop layer 300 that surrounds a part of an outer circumferential surface of the cylinder part 110; and a second hoop layer forming step S40 of forming second hoop layers 400 that surround the other parts of the outer circumferential surface of the cylinder part 110 and each have a thickness that gradually decreases in a direction from the cylinder part 110 to the side part 120.

For reference, a pressure vessel 10 according to embodiments of the present disclosure may be used to store a high-pressure fluid (liquid or gas), and the present disclosure is not restricted or limited by the type and the property of the fluid stored in the pressure vessel 10.

Hereinafter, a configuration in which the pressure vessel 10 according to embodiments of the present disclosure is used as a hydrogen tank of a hydrogen storage system applied to a hydrogen vehicle will be described as an example.

### Step 1:

First, the liner 100 including the cylinder part 110 and the side parts 120 is provided (S10).

In the preparation step S10, the liner 100 in which the dome-shaped side parts 120 are integrally formed at both ends of the cylinder part 110 is provided.

The liner 100 has a hollow structure having a storage space therein, and high-pressure compressed hydrogen may be stored in the storage space.

An inlet port (not illustrated), through which hydrogen is introduced, may be formed at one end of the liner 100, and an outlet port (not illustrated), through which the hydrogen is discharged, may be formed at the other end of the liner 100.

The material of the liner 100 may be variously changed in accordance with required conditions and design specifications, and the present disclosure is not limited or restricted by the material of the liner 100. In particular, the liner 100 may be made of a nonmetallic material such as high-density plastic with excellent restoring force and excellent fatigue resistance.

More specifically, the liner 100 includes the cylinder part 110 having a hollow cylindrical shape, and the dome-shaped side parts 120 integrally formed at both ends of the cylinder part 110.

### Step 2:

According to embodiments of the present disclosure, the method of manufacturing the pressure vessel may include a first helical layer forming step S20 of forming a first helical layer 600 that surrounds an outer surface of the liner 100.

In the first helical layer forming step S20, the first helical layer 600 may be formed by winding a carbon fiber composite material, which is made by impregnating carbon fibers with epoxy, thermosetting resin, and the like, around the outer surface of the liner 100 (an outer surface of the cylinder part and outer surfaces of the side parts) by using a typical winding device.

For reference, in embodiments of the present disclosure, the first helical layer 600 may be defined as a layer provided to reinforce structural rigidity for resisting torsion and stress, applied mainly in a longitudinal direction (a longitudinal direction of the cylinder part), of stress applied to the liner. The first helical layer 600 may be provided to resist the torsion and stress applied in the longitudinal direction of the liner 100 in cooperation with a second helical layer 700 to be described below.

For example, the first helical layer 600 may be formed by winding the carbon fiber composite material around the outer surface of the cylinder part 110 at a winding angle of 45° to 88° with respect to an axis of the cylinder part 110, and the present disclosure is not restricted or limited by winding angles and winding patterns (e.g., clockwise winding, counterclockwise winding, oblique winding, and the like) of the carbon fiber composite material for forming the first helical layer 600.

In particular, the first helical layer 600 may have a thickness TH1 equal to or smaller than 5% of a whole thickness WT of a carbon fiber layer 200 so as to ensure structural rigidity implemented by the first helical layer 600 and minimize an increase in thickness and weight of the pressure vessel 10.

In this case, the whole thickness WT of the carbon fiber layer 200 may be understood as a maximum thickness of the carbon fiber layer 200 in a radial direction of the cylinder part 110.

For example, assuming that the whole thickness WT of the layers (e.g., the first helical layer, the first hoop layer, the second helical layer, and the third hoop layer) constituting the carbon fiber layer 200 is 20 mm, the first helical layer 600 may be formed to have a thickness TH of 1 mm or less.

### Step 3:

Next, the first hoop layer 300 is formed to surround a part of the outer circumferential surface of the cylinder part 110 (S30).

In the first hoop layer forming step S30, the first hoop layer 300 may be formed by winding a carbon fiber composite material, which is made by impregnating carbon fibers with epoxy, thermosetting resin, and the like, around the outer surface (outer circumferential surface) of the cylinder part no by using the typical winding device.

For example, in the case in which the first helical layer 600 is provided on the outer surface of the liner 100, the first hoop layer 300 may be formed on an outer surface of the first helical layer 600 so as to surround a part of the outer circumferential surface of the cylinder part no. According to another embodiment of the present disclosure, the first hoop layer may be formed directly on the outer surface of the liner in a state in which no separate first helical layer is provided on the outer surface of the liner.

For reference, in embodiments of the present disclosure, the first hoop layer 300 may be defined as a layer for (ensuring structural rigidity) resisting stress (e.g., maximum hoop stress), applied mainly in a circumferential direction, of stress applied to the cylinder part 110.

For example, the first hoop layer 300 may be formed by winding the carbon fiber composite material around the outer surface of the cylinder part no (the outer surface of the first helical layer) at a winding angle of 89° to 91° with respect to the axis of the cylinder part no. According to another embodiment of the present disclosure, the first hoop layer may be formed by winding the carbon fiber composite material at a winding angle of 85° to 89° with respect to the axis of the cylinder part.

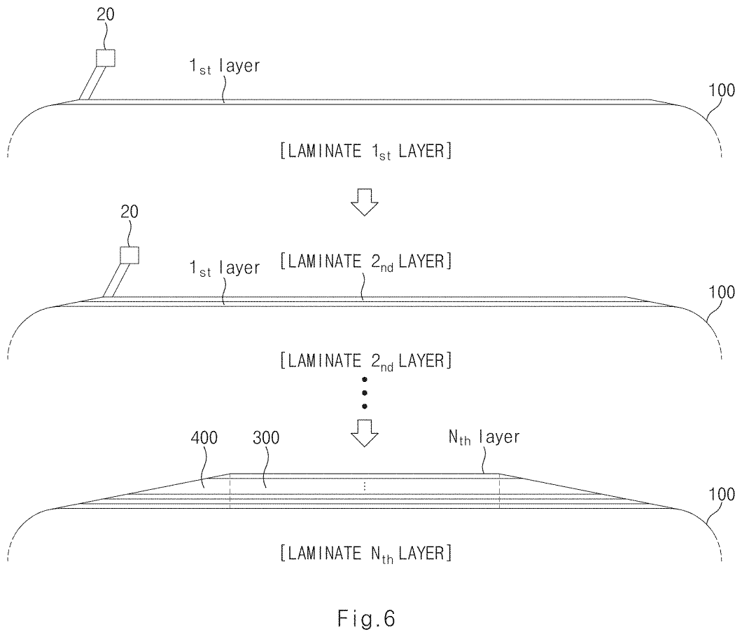

For example, the carbon fiber composite material may be wound around the outer surface of the cylinder part 110 by a winding jig 20 (see FIG. 6). The winding angle of the carbon fiber composite material with respect to the cylinder part 110 may be changed by adjusting an angle (posture) at which the winding jig 20 (see FIG. 6) is disposed with respect to the cylinder part 110.

In particular, in the first hoop layer forming step S30, the first hoop layer 300 may be formed to have a first thickness T1 that may resist maximum hoop stress applied to the cylinder part 110. The first thickness T1 of the first hoop layer 300 may be variously changed in accordance with required conditions and design specifications (e.g., the structure and the size of the pressure vessel).

### Step 4:

Next, the second hoop layers 400 are formed to surround the other parts of the outer circumferential surface of the cylinder part 110 (S40).

In the second hoop layer forming step S40, the second hoop layer 400 may be formed by winding a carbon fiber composite material, which is made by impregnating carbon fibers with epoxy, thermosetting resin, and the like, around the outer surface (outer circumferential surface) of the cylinder part 110 by using the typical winding device.

For reference, in embodiments of the present disclosure, the second hoop layer 400 may be defined as a layer for (ensuring structural rigidity) resisting stress (hoop stress), applied mainly in the circumferential direction, of stress applied to the cylinder part 110.

For example, the second hoop layer 400 may be formed by winding the carbon fiber composite material around the outer surface of the cylinder part 110 at a winding angle of 89° to 91° with respect to the axis of the cylinder part 110. According to another embodiment of the present disclosure, the second hoop layer may be formed by winding the carbon fiber composite material at a winding angle of 85° to 89° with respect to the axis of the cylinder part.

In particular, in the second hoop layer forming step S40, the second hoop layer 400 is formed to have a thickness that gradually decreases in the direction from the cylinder part 110 to the side part 120. More particularly, the thickness of the second hoop layer 400 may linearly decrease in the direction from the cylinder part 110 to the side part 120.

According to embodiments of the present disclosure, the first hoop layer 300 may be provided to surround a central region of the cylinder part 110 in the first hoop layer forming step S30, and the second hoop layers 400 may be provided to surround two edge regions of the cylinder part 110 with the first hoop layer 300 interposed therebetween in the second hoop layer forming step S40.

In particular, a center of the first hoop layer 300 corresponds to a center C of the cylinder part, a length of the first hoop layer 300 is 40% to 60% of a length L of the cylinder part 110, and a length of the second hoop layer 400 is 20% to 30% of the length L of the cylinder part 110.

That is, if the length of the first hoop layer 300 is less than 40% of the length L of the cylinder part 110, there is a problem in that bursting strength of the pressure vessel is decreased. If the length of the first hoop layer 300 is more than 70% of the length L of the cylinder part 110, there is a problem in that the amount of use of the carbon fiber composite material is increased, and hydrogen weight efficiency (wt. %) of the pressure vessel 10 deteriorates. Therefore, the length of the first hoop layer 300 may be 40% to 60% of the length L of the cylinder part 110, and the length of the second hoop layer 400 may be 20% to 30% of the length L of the cylinder part 110.

According to another embodiment of the present disclosure, an overall length (L2+L1+L2) of the first and second hoop layers may be shorter than the overall length L of the cylinder part (L2+L1+L2<L). Alternatively, the overall length (L2+L1+L2) of the first and second hoop layers may be longer than the overall length L of the cylinder part (L2+L1+L2>L). In particular, the overall length (L2+L1+L2) of the first and second hoop layers may be ±10% of the overall length L of the cylinder part (e.g., 90% of the length L or 110% of the length L).

More particularly, the center of the first hoop layer 300 corresponds to the center C of the cylinder part 110, and the length L1 of the first hoop layer 300 is defined by the following Equation 1:

L1=L/2, [Equation 1]

where L is the length of the cylinder part 110.

In addition, the length L2 of the second hoop layer 400 is defined by the following Equation 2:

L2=L/4, [Equation 2]

where L is the length of the cylinder part 110.

According to embodiments of the present disclosure, the second hoop layer 400 is provided to have a right-angled triangular cross section having a height H corresponding to the thickness of the first hoop layer 300, and an angle θ between a hypotenuse HL and a base line of the right-angled triangular cross section may satisfy the following Equation 3:

tan θ=H/L2, [Equation 3]

where H is the height of the right-angled triangular cross section, and L2 is the length of the second hoop layer corresponding to the base line of the right-angled triangular cross section.

This is derived from the fact that the hoop stress applied to the central region of the cylinder part 110 (the section in which the first hoop layer is formed) is highest and the hoop stress applied to the two edge regions of the cylinder part 110 (the sections in which the second hoop layers are formed) is gradually decreased as the distance from the side part 120 is decreased.

The stress (hoop stress) applied to the cylinder part 110 is not uniform over the entire section of the cylinder part 110.

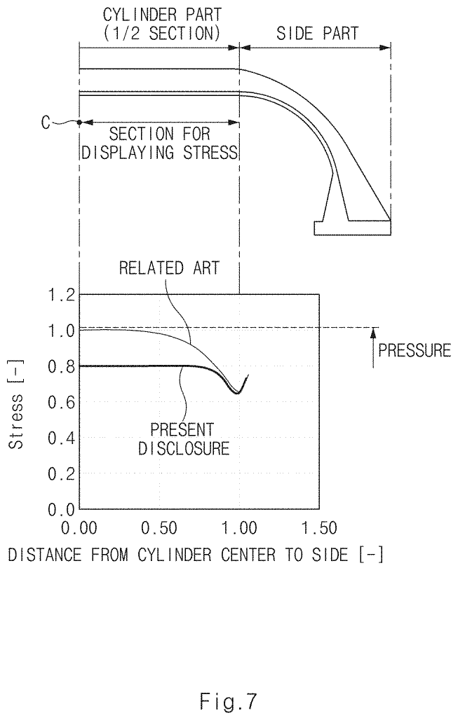

That is, referring to FIG. 7, it can be ascertained that the stress (hoop stress) applied to the cylinder part 110 is high in the central region of the cylinder part 110 (the region where the distance from the center C of the cylinder part is 0.00 to 0.50 meter), and the stress (hoop stress) applied to the cylinder part 110 is gradually decreased in the edge region of the cylinder part 110 (the region where the distance from the center of the cylinder part is 0.50 to 1.00 meter) as the distance from the side part 120 is decreased.

In particular, it can be ascertained that the stress (maximum hoop stress) is concentrated in the central region of the cylinder part 110 (the region where the distance from the center of the cylinder part is 0.00 to 0.50 meter) and the stress (hoop stress) is rapidly decreased in the edge region of the cylinder part 110 (the region where the distance from the center of the cylinder part is 0.50 to 1.00 meter).

In embodiments of the present disclosure as described above, the thickness of the first hoop layer 300, which is formed in the section to which the relatively high hoop stress is applied (in the central region of the cylinder part where the hoop stress is concentrated), is large, whereas the thickness of the second hoop layer 400, which is formed in the section to which the relatively low hoop stress is applied (in the edge region of the cylinder part), is gradually decreased as the distance from the side part 120 is decreased. As a result, it is possible to ensure sufficient structural rigidity against the hoop stress applied to the cylinder part 110, and it is possible to reduce the amount of use of the carbon fiber composite material, which is used to form the second hoop layer 400, to the extent that the thickness of the second hoop layer 400 is reduced. As a result, it is possible to obtain an advantageous effect of reducing a weight of the pressure vessel 10 and reducing manufacturing costs.

In addition, according to embodiments of the present disclosure, the thickness of the first hoop layer 300 formed in the section to which the relatively high hoop stress is applied is large, whereas the thickness of the second hoop layer 400 formed in the section to which the relatively low hoop stress is applied is gradually decreased as the distance from the side part 120 is decreased, such that the deviation of the stress applied to the cylinder part 110 may be reduced (the stress may be made more uniform). As a result, it is possible to obtain an advantageous effect of reducing stress to be applied to a weak section (e.g., the central region) of the cylinder part 110 and further improving the margin of safety.

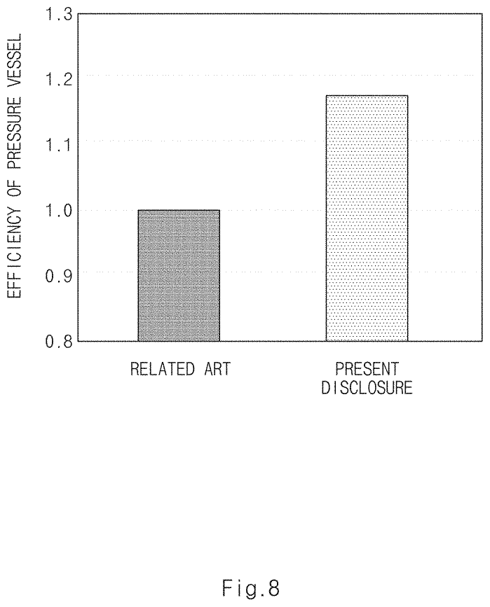

Since the stress applied to the cylinder part 110 is made more uniform (the deviation is reduced) as a whole as described above, it is possible to obtain an advantageous effect of improving efficiency (normalized efficiency) of the pressure vessel 10 by about 18%, as illustrated in FIG. 8, in comparison with a pressure vessel in the related art (a pressure vessel in which a hoop layer and a helical layer, which each have a constant thickness as a whole, are laminated).

For reference, in embodiments of the present disclosure illustrated and described above, the example in which the thickness of the second hoop layer 400 linearly decreases in the direction from the cylinder part 110 to the side part 120 has been described. However, according to another embodiment of the present disclosure, the thickness of the second hoop layer may nonlinearly decrease in the direction from the cylinder part to the side part. For example, an upper surface of the second hoop layer (a portion corresponding to the hypotenuse of the right-angled triangle) may be curved.

In embodiments of the present disclosure, the order and the method of forming the first hoop layer 300 and the second hoop layer 400 may be variously changed in accordance with required conditions and design specifications, and the present disclosure is not restricted or limited by the order and the method of forming the first hoop layer 300 and the second hoop layer 400.

For example, the first hoop layer 300 and the second hoop layer 400 may be formed by separate winding processes, respectively. For example, the first hoop layer 300 may be formed first, and then the second hoop layer 400 may be formed. Alternatively, the second hoop layer 400 may be formed first, and then the first hoop layer 300 may be formed.

As another example, the first hoop layer 300 and the second hoop layer 400 may be continuously formed by the same winding process. More specifically, referring to FIG. 6, as the winding jig 20 rectilinearly moves in the longitudinal direction of the liner 100 (the longitudinal direction of the cylinder part), the carbon fiber composite material is wound around the outer circumferential surface of the cylinder part in such a manner that a first winding layer (1st layer) including a part of the first hoop layer 300 and a part of the second hoop layer 400 is continuously formed, and then a second winding layer (2nd layer) having a shorter length (in the longitudinal direction of the cylinder part) than the first winding layer is laminated on an outer surface of the first winding layer. In this way, the N winding layers, which have lengths that gradually decrease outward in the radial direction of the cylinder part, are laminated (a Nth layer is laminated on an outermost peripheral surface of the cylinder part), such that the first hoop layer 300 and the second hoop layer 400 may be formed.

### Step 5:

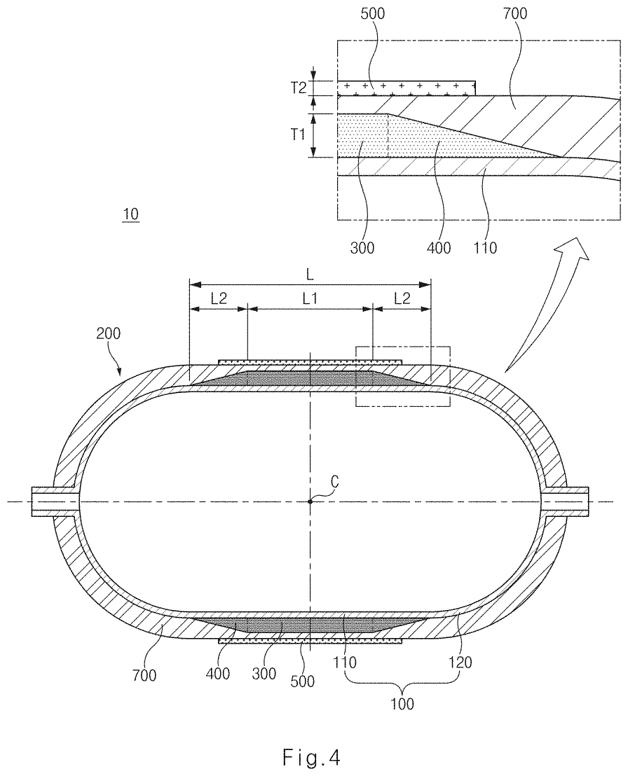

Referring to FIG. 4, according to embodiments of the present disclosure, the method of manufacturing the pressure vessel may include a second helical layer forming step S50 of forming the second helical layer 700 that surrounds the outer surface of the first hoop layer 300, the outer surfaces of the second hoop layers 400, and the outer surfaces of the side parts 120.

In the second helical layer forming step S50, the second helical layer 700 may be formed by winding a carbon fiber composite material, which is made by impregnating carbon fibers with epoxy, thermosetting resin, and the like, around the outer surface of the first hoop layer 300, the outer surfaces of the second hoop layers 400, and the outer surfaces of the side parts 120 by using the typical winding device.

For reference, in embodiments of the present disclosure, the second helical layer 700 may be defined as a layer provided to ensure structural rigidity for resisting torsion and stress, applied mainly in the longitudinal direction, of stress applied to the cylinder part 110.

For example, the second helical layer 700 may be formed by winding the carbon fiber composite material around the outer surface of the cylinder part 110 at a winding angle of 45° to 88° with respect to the axis of the cylinder part 110, and the present disclosure is not restricted or limited by winding patterns (e.g., clockwise winding, counterclockwise winding, oblique winding, and the like) of the carbon fiber composite material for forming the second helical layer 700.

### Step 6:

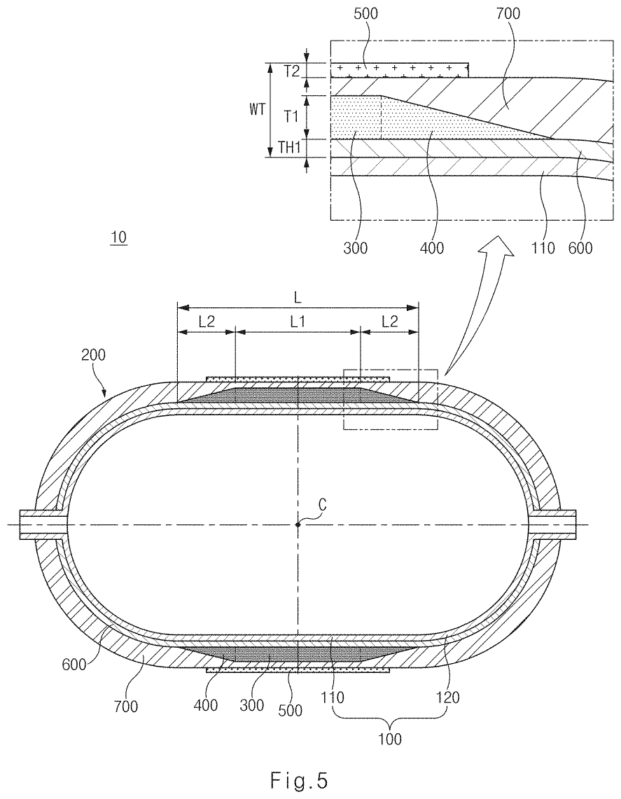

Referring to FIG. 5, according to embodiments of the present disclosure, the method of manufacturing the pressure vessel may include a third hoop layer forming step S60 of forming a third hoop layer 500 that covers an outer surface of the second helical layer 700.

In this case, the configuration in which the third hoop layer 500 is formed to cover the outer surface of the second helical layer 700 may include both a configuration in which the third hoop layer 500 is formed to have a length (in the longitudinal direction of the cylinder part) corresponding to the length of the first hoop layer 300 and a configuration in which the third hoop layer 500 is formed to have a longer length than the first hoop layer 300. Hereinafter, the configuration in which the third hoop layer 500 is formed to have a longer length than the first hoop layer 300 and the third hoop layer 500 is formed to cover the entire region of the first hoop layer 300 and partially cover a part of the region of the second hoop layer 400 will be described as an example.

In the third hoop layer forming step S60, the third hoop layer 500 may be formed by winding a carbon fiber composite material, which is made by impregnating carbon fibers with epoxy, thermosetting resin, and the like, around the outer surface (outer circumferential surface) of the second helical layer 700 by the typical winding device.

For reference, in embodiments of the present disclosure, the third hoop layer 500 may be defined as a layer provided to reinforce structural rigidity for resisting stress, applied mainly in the circumferential direction, of stress applied to the cylinder part 110.

For example, the third hoop layer 500 may be formed by winding the carbon fiber composite material around the outer surface of the second helical layer 700 at a winding angle of 89° to 91° with respect to the axis of the cylinder part 110. According to another embodiment of the present disclosure, the third hoop layer may be formed by winding the carbon fiber composite material at a winding angle of 85° to 89° with respect to the axis of the cylinder part.

For example, the carbon fiber composite material may be wound around the outer surface of the cylinder part 110 by the winding jig 20 (see FIG. 6). The winding angle of the carbon fiber composite material with respect to the cylinder part 110 may be changed by adjusting an angle (posture) at which the winding jig 20 (see FIG. 6) is disposed with respect to the cylinder part 110.

According to embodiments of the present disclosure, in the third hoop layer forming step S60, the third hoop layer 500 may be provided to have a second thickness T2 smaller than the first thickness T1 of the first hoop layer 300.

For example, the first hoop layer 300 may be provided to have a thickness equal to or larger than 90% of a preset reference hoop layer thickness.

As another example, the third hoop layer 500 may be provided to have a thickness less than 10% of the preset reference hoop layer thickness.

In this case, the reference hoop layer thickness may be defined as a whole hoop layer thickness (the thickness of the first hoop layer+the thickness of the third hoop layer) which is defined in the radial direction of the cylinder part 110 and set to resist maximum hoop stress (e.g., hoop stress based on damage to the pressure vessel) applied to the liner 100.

For example, assuming that the reference hoop layer thickness is 10 mm, the first hoop layer 300 may be formed to have a thickness of 9 mm or more, and the third hoop layer 500 may be formed to have a thickness less than 1 mm.

Hereinafter, the pressure vessel 10 manufactured by the method of manufacturing the pressure vessel according to embodiments of the present disclosure will be described.

Referring to FIG. 5, the pressure vessel 10 according to embodiments of the present disclosure includes the liner 100 including the cylinder part 110, and the dome-shaped side parts 120 provided at both ends of the cylinder part 110, and the carbon fiber layer 200 including the first hoop layer 300 provided to surround a part of the outer circumferential surface of the cylinder part 110, and the second hoop layers 400 provided to surround the other parts of the outer circumferential surface of the cylinder part 110 and each having a thickness that gradually decreases in the direction from the cylinder part 110 to the side part 120.

The liner 100 includes the cylinder part 110 having a hollow cylindrical shape, and the dome-shaped side parts 120 integrally formed at both ends of the cylinder part 110.

The liner 100 has a hollow structure having a storage space therein, and high-pressure compressed hydrogen may be stored in the storage space.

An inlet port (not illustrated), through which hydrogen is introduced, may be formed at one end of the liner 100, and an outlet port (not illustrated), through which the hydrogen is discharged, may be formed at the other end of the liner 100.

The material of the liner 100 may be variously changed in accordance with required conditions and design specifications, and the present disclosure is not limited or restricted by the material of the liner 100. In particular, the liner 100 may be made of a nonmetallic material such as high-density plastic with excellent restoring force and excellent fatigue resistance.

According to embodiments of the present disclosure, the pressure vessel 10 may include the first helical layer 600 provided to surround the outer surface of the liner 100.

For reference, in embodiments of the present disclosure, the first helical layer 600 may be defined as a layer provided to reinforce structural rigidity for resisting torsion and stress, applied mainly in a longitudinal direction (a longitudinal direction of the cylinder part), of stress applied to the liner. The first helical layer 600 may be provided to resist the torsion and stress applied in the longitudinal direction of the liner 100 in cooperation with a second helical layer 700 to be described below.

The first helical layer 600 may be formed by winding a carbon fiber composite material, which is made by impregnating carbon fibers with epoxy, thermosetting resin, and the like, around the outer surface of the liner 100 (the outer surface of the cylinder part and the outer surfaces of the side parts) by using the typical winding device.

For example, the first helical layer 600 may be formed by winding the carbon fiber composite material around the outer surface of the cylinder part 110 at a winding angle of 45° to 88° with respect to the axis of the cylinder part 110, and the present disclosure is not restricted or limited by winding angles and winding patterns (e.g., clockwise winding, counterclockwise winding, oblique winding, and the like) of the carbon fiber composite material for forming the first helical layer 600.

In particular, the first helical layer 600 may have a thickness TH equal to or smaller than 5% of the whole thickness of the carbon fiber layer 200 so as to ensure structural rigidity implemented by the first helical layer 600 and minimize an increase in thickness and weight of the pressure vessel 10.

In this case, the whole thickness WT of the carbon fiber layer 200 may be understood as a maximum thickness of the carbon fiber layer 200 in the radial direction of the cylinder part 110.

For example, assuming that the whole thickness WT of the layers (e.g., the first helical layer, the first hoop layer, the second helical layer, and the third hoop layer) constituting the carbon fiber layer 200 is 20 mm, the first helical layer 600 may be formed to have a thickness TH of 1 mm or less.

The first hoop layer 300 is provided to surround a part of the outer circumferential surface of the cylinder part 110.

For reference, in embodiments of the present disclosure, the first hoop layer 300 may be defined as a layer for (ensuring structural rigidity) resisting stress (e.g., maximum hoop stress), applied mainly in a circumferential direction, of stress applied to the cylinder part 110.

For example, in the case in which the first helical layer 600 is provided on the outer surface of the liner 100, the first hoop layer 300 may be formed on the outer surface of the first helical layer 600 so as to surround a part of the outer circumferential surface of the cylinder part 110.

The first hoop layer 300 may be formed by winding the carbon fiber composite material, which is made by impregnating carbon fibers with epoxy, thermosetting resin, and the like, around the outer surface (outer circumferential surface) of the cylinder part 110 by using the typical winding device.

For example, the first hoop layer 300 may be formed by winding the carbon fiber composite material around the outer surface of the cylinder part 110 at a winding angle (first winding angle) of 89° to 91° with respect to the axis of the cylinder part 110. According to another embodiment of the present disclosure, the first hoop layer may be formed by winding the carbon fiber composite material at a winding angle of 85° to 89° with respect to the axis of the cylinder part.

In particular, the first hoop layer 300 may be formed to have the first thickness T1 that may resist maximum hoop stress applied to the cylinder part 110. The first thickness T1 of the first hoop layer 300 may be variously changed in accordance with required conditions and design specifications (e.g., the structure and the size of the pressure vessel).

The second hoop layers 400 are provided to surround the other parts of the outer circumferential surface of the cylinder part 110.

For reference, in embodiments of the present disclosure, the second hoop layer 400 may be defined as a layer for (ensuring structural rigidity) resisting stress (hoop stress), applied mainly in the circumferential direction, of stress applied to the cylinder part 110.

The second hoop layer 400 may be formed by winding the carbon fiber composite material, which is made by impregnating carbon fibers with epoxy, thermosetting resin, and the like, around the outer surface (outer circumferential surface) of the cylinder part 110 by using the typical winding device.

For example, the second hoop layer 400 may be formed by winding the carbon fiber composite material around the outer surface of the cylinder part 110 at a winding angle (second winding angle) of 89° to 91° with respect to the axis of the cylinder part 110. According to another embodiment of the present disclosure, the second hoop layer may be formed by winding the carbon fiber composite material at a winding angle of 85° to 89° with respect to the axis of the cylinder part.

In particular, the second hoop layer 400 is formed to have a thickness that gradually decreases in the direction from the cylinder part 110 to the side part 120. More particularly, the thickness of the second hoop layer 400 may linearly decrease in the direction from the cylinder part 110 to the side part 120.

According to embodiments of the present disclosure, the first hoop layer 300 is provided to surround the central region of the cylinder part 110, and the second hoop layers 400 are provided to surround the two edge regions of the cylinder part 110 with the first hoop layer 300 interposed therebetween.

In particular, the center of the first hoop layer 300 corresponds to the center C of the cylinder part, the length of the first hoop layer 300 is 40% to 60% of the length L of the cylinder part 110, and the length of the second hoop layer 400 is 20% to 30% of the length L of the cylinder part 110.

More particularly, the center of the first hoop layer 300 corresponds to the center C of the cylinder part 110, and the length L1 of the first hoop layer 300 is defined by the following Equation 1:

L1=L/2, [Equation 1]

where L is the length of the cylinder part 110.

In addition, the length L2 of the second hoop layer 400 is defined by the following Equation 2:

L2=L/4, [Equation 2]

where L is the length of the cylinder part 110.

According to embodiments of the present disclosure, the second hoop layer 400 is provided to have a right-angled triangular cross section having a height H corresponding to the thickness of the first hoop layer 300, and an angle θ between a hypotenuse HL and a base line of the right-angled triangular cross section may satisfy the following Equation 3:

tan θ=H/L2, [Equation 3]

where H is the height of the right-angled triangular cross section, and L2 is the length of the second hoop layer corresponding to the base line of the right-angled triangular cross section.

This is derived from the fact that the hoop stress applied to the central region of the cylinder part 110 (the section in which the first hoop layer is formed) is highest and the hoop stress applied to the two edge regions of the cylinder part 110 (the sections in which the second hoop layers 400 are formed) is gradually decreased as the distance from the side part 120 is decreased.

The stress (hoop stress) applied to the cylinder part 110 is not uniform over the entire section of the cylinder part 110.

That is, referring to FIG. 7, it can be ascertained that the stress (hoop stress) applied to the cylinder part 110 is high in the central region of the cylinder part 110 (the region where the distance from the center C of the cylinder part is 0.00 to 0.50 meter), and the stress (hoop stress) applied to the cylinder part 110 is gradually decreased in the edge region of the cylinder part 110 (the region where the distance from the center of the cylinder part is 0.50 to 1.00 meter) as the distance from the side part 120 is decreased.

In particular, it can be ascertained that the stress (maximum hoop stress) is concentrated in the central region of the cylinder part 110 (the region where the distance from the center of the cylinder part is 0.00 to 0.50 meter) and the stress (hoop stress) is rapidly decreased in the edge region of the cylinder part 110 (the region where the distance from the center of the cylinder part is 0.50 to 1.00 meter).

In embodiments of the present disclosure as described above, the thickness of the first hoop layer 300, which is formed in the section to which the relatively high hoop stress is applied (in the central region of the cylinder part where the hoop stress is concentrated), is large, whereas the thickness of the second hoop layer 400, which is formed in the section to which the relatively low hoop stress is applied (in the edge region of the cylinder part), is gradually decreased as the distance from the side part 120 is decreased. As a result, it is possible to ensure sufficient structural rigidity against the hoop stress applied to the cylinder part 110, and it is possible to reduce the amount of use of the carbon fiber composite material, which is used to form the second hoop layer 400, to the extent that the thickness of the second hoop layer 400 is reduced. As a result, it is possible to obtain an advantageous effect of reducing a weight of the pressure vessel 10 and reducing manufacturing costs.

In addition, according to embodiments of the present disclosure, the thickness of the first hoop layer 300 formed in the section to which the relatively high hoop stress is applied is large, whereas the thickness of the second hoop layer 400 formed in the section to which the relatively low hoop stress is applied is gradually decreased as the distance from the side part 120 is decreased, such that the deviation of the stress applied to the cylinder part 110 may be reduced (the stress may be made more uniform). As a result, it is possible to obtain an advantageous effect of reducing stress to be applied to a weak section (e.g., the central region) of the cylinder part 110 and further improving the margin of safety.

Since the stress applied to the cylinder part 110 is made more uniform (the deviation is reduced) as a whole as described above, it is possible to obtain an advantageous effect of improving efficiency (normalized efficiency) of the pressure vessel 10 by about 18%, as illustrated in FIG. 8, in comparison with a pressure vessel in the related art (a pressure vessel in which a hoop layer and a helical layer, which each have a constant thickness as a whole, are laminated).

For reference, in embodiments of the present disclosure, the order and the method of forming the first hoop layer 300 and the second hoop layer 400 may be variously changed in accordance with required conditions and design specifications, and the present disclosure is not restricted or limited by the order and the method of forming the first hoop layer 300 and the second hoop layer 400.

For example, the first hoop layer 300 and the second hoop layer 400 may be continuously formed by the same winding process. More specifically, referring to FIG. 6, as the winding jig 20 rectilinearly moves in the longitudinal direction of the liner 100 (the longitudinal direction of the cylinder part), the carbon fiber composite material is wound around the outer circumferential surface of the cylinder part in such a manner that a first winding layer (1st layer) including a part of the first hoop layer 300 and a part of the second hoop layer 400 is continuously formed, and then a second winding layer (2nd layer) having a shorter length (in the longitudinal direction of the cylinder part) than the first winding layer is laminated on an outer surface of the first winding layer. In this way, the N winding layers, which have lengths that gradually decrease outward in the radial direction of the cylinder part, are laminated (a Nth layer is laminated on an outermost peripheral surface of the cylinder part), such that the first hoop layer 300 and the second hoop layer 400 may be formed.

According to embodiments of the present disclosure, the pressure vessel 10 may include the second helical layer 700 formed to surround the outer surface of the first hoop layer 300, the outer surfaces of the second hoop layers 400, and the outer surfaces of the side parts 120 (or the outer surface of the first helical layer).

For reference, in embodiments of the present disclosure, the second helical layer 700 may be defined as a layer provided to ensure structural rigidity for resisting torsion and stress, applied mainly in the longitudinal direction, of stress applied to the cylinder part 110.

The second helical layer 700 may be formed by winding a carbon fiber composite material, which is made by impregnating carbon fibers with epoxy, thermosetting resin, and the like, around the outer surface of the first hoop layer 300, the outer surfaces of the second hoop layers 400, and the outer surfaces of the side parts 120 (or the outer surface of the first helical layer) by using the typical winding device.

For example, the second helical layer 700 may be formed by winding the carbon fiber composite material around the outer surface of the cylinder part 110 at a winding angle of 45° to 88° with respect to the axis of the cylinder part 110.

According to embodiments of the present disclosure, the pressure vessel 10 may include the third hoop layer 500 formed to cover the outer surface of the second helical layer 700.

For example, the third hoop layer 500 is formed to have a longer length than the first hoop layer 300 and the third hoop layer 500 is formed to cover the entire region of the first hoop layer 300 and partially cover a part of the region of the second hoop layer 400. According to another embodiment of the present disclosure, the third hoop layer may be formed to have a length (in the longitudinal direction of the cylinder part) corresponding to the length of the first hoop layer.

For reference, in embodiments of the present disclosure, the third hoop layer 500 may be defined as a layer provided to reinforce structural rigidity for resisting stress, applied mainly in the circumferential direction, of stress applied to the cylinder part 110.

The third hoop layer 500 may be formed by winding a carbon fiber composite material, which is made by impregnating carbon fibers with epoxy, thermosetting resin, and the like, around the outer surface (outer circumferential surface) of the second helical layer 700 by using the typical winding device.

For example, the third hoop layer 500 may be formed by winding the carbon fiber composite material around the outer surface of the second helical layer 700 at a winding angle of 89° to 91° with respect to the axis of the cylinder part 110. According to another embodiment of the present disclosure, the third hoop layer may be formed by winding the carbon fiber composite material at a winding angle of 85° to 89° with respect to the axis of the cylinder part.

In particular, the third hoop layer 500 may be provided to have the second thickness T2 smaller than the first thickness T1 of the first hoop layer 300.

For example, the first hoop layer 300 may be provided to have a thickness equal to or larger than 90% of the preset reference hoop layer thickness.

As another example, the third hoop layer 500 may be provided to have a thickness less than 10% of the preset reference hoop layer thickness.

In this case, the reference hoop layer thickness may be defined as a whole hoop layer thickness (the thickness of the first hoop layer+the thickness of the third hoop layer) which is defined in the radial direction of the cylinder part 110 and set to resist maximum hoop stress (e.g., hoop stress based on damage to the pressure vessel) applied to the liner 100.

For example, assuming that the reference hoop layer thickness is 10 mm, the first hoop layer 300 may be formed to have a thickness of 9 mm or more, and the third hoop layer 500 may be formed to have a thickness less than 1 mm.

Meanwhile, the carbon fiber layer 200 (e.g., the first helical layer, the first hoop layer, the second hoop layers, and the second helical layer) wound around the outer surface of the liner 100 may be cured through a subsequent heat treatment process.

In embodiments of the present disclosure described and illustrated above, the example in which the pressure vessel includes the single carbon fiber layer including the first hoop layer, the second hoop layers, and the second helical layer has been described. However, according to another embodiment of the present disclosure, the pressure vessel may include a plurality of carbon fiber layers.

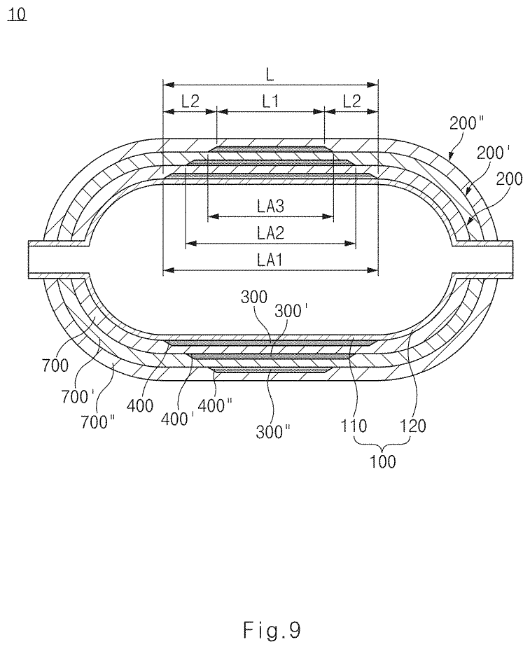

For example, referring to FIG. 9, the pressure vessel 10 may include the liner 100 including the cylinder part 110, and the dome-shaped side parts 120 provided at both ends of the cylinder part 110, and carbon fiber layers 200, 200′, and 200″ including first hoop layers 300, 300′, and 300″ provided to surround a part of the outer circumferential surface of the cylinder part 110, second hoop layers 400, 400′, and 400″ provided to surround the other parts of the outer circumferential surface of the cylinder part 110 and each having a thickness that gradually decreases in the direction from the cylinder part 110 to the side part 120, and second helical layers 700, 700′, and 700″ provided to surround the outer surfaces of the first hoop layers 300, 300′, and 300″, the outer surfaces of the second hoop layers 400, 400′, and 400″, and the outer surfaces of the side parts 120, in which the plurality of carbon fiber layers 200, 200′, and 200″ may be laminated (in the radial direction of the liner).

The number of laminated carbon fiber layers 200, 200′, and 200″ may be variously changed in accordance with required conditions and design specifications, and the present disclosure is not restricted or limited by the number of laminated carbon fiber layers 200, 200′, and 200″.

Hereinafter, an example in which three carbon fiber layers 200, 200′, and 200″ are laminated on the outer surface of the liner 100 will be described. According to another embodiment of the present disclosure, two carbon fiber layers may be laminated on the outer surface of the liner or four or more carbon fiber layers may be laminated on the outer surface of the liner.

In addition, according to another embodiment of the present disclosure, even in the case in which the plurality of carbon fiber layers 200, 200′, and 200″ is laminated, each of the carbon fiber layers 200, 200′, and 200″ may include the first helical layer 600 (see FIG. 5) and the third hoop layer 500 (see FIG. 5). In other words, a plurality of carbon fiber layers including the first hoop layer, the second hoop layer, the third hoop layer, the first helical layer, and the second helical layer may be laminated.

In particular, overall lengths LA1, LA2, and LA3 of the first hoop layers 300, 300′, and 300″ and the second hoop layers 400, 400′, and 400″, which constitute the carbon fiber layers 200, 200′, and 200″, respectively, may be gradually decreased (LA1>LA2>LA3) outward in the radial direction of the liner 100.

That is, the first hoop layer 300 and the second hoop layer 400, which constitute the carbon fiber layer 200 formed by a first winding process (primary winding process), may have a first length LA1, the first hoop layer 300′ and the second hoop layer 400′, which constitute the carbon fiber layer 200′ formed by a subsequent second winding process (secondary winding process), may have a second length LA2 shorter than the first length LA1, and the first hoop layer 300″ and the second hoop layer 400″, which constitute the carbon fiber layer 200″ formed by a final third winding process (tertiary winding process), may have a third length LA3 shorter than the second length LA2.

As described above, since the overall lengths LA1, LA2, and LA3 of the first hoop layers 300, 300′, and 300″ and the second hoop layers 400, 400′, and 400″, which constitute the plurality of carbon fiber layers 200, 200′, and 200″, are gradually decreased (LA1>LA2>LA3) outward in the radial direction of the liner 100, it is possible to ensure sufficient structural rigidity against the hoop stress in the section to which the relatively high hoop stress is applied, and it is possible to reduce the amount of use of the carbon fiber composite material in the section to which the relatively low hoop stress is applied. As a result, it is possible to obtain an advantageous effect of improving hydrogen weight efficiency (wt. %) of the pressure vessel 10.

According to another embodiment of the present disclosure, the plurality of carbon fiber layers including the first hoop layers and the second hoop layers may be laminated in the radial direction of the liner, and the overall lengths of the first hoop layers and the second hoop layers, which constitute the carbon fiber layers, respectively, may be equal to one another (e.g., LA1=LA2=LA3).

While embodiments have been described above, the embodiments are just illustrative and not intended to limit the present disclosure. It can be appreciated by those skilled in the art that various modifications and alterations, which are not described above, may be made to the present embodiments without departing from the intrinsic features of the present embodiments. For example, the respective constituent elements specifically described in the embodiments may be modified and then carried out. Further, it should be interpreted that the differences related to the modifications and alterations are included in the scope of the present disclosure defined by the appended claims.

What is claimed is:

1. A pressure vessel comprising:
a liner comprising a cylinder part and dome-shaped side parts at both ends of the cylinder part; and
a carbon fiber layer comprising a first hoop layer surrounding a part of an outer circumferential surface of the cylinder part and second hoop layers surrounding remaining parts of the outer circumferential surface of the cylinder part, each of the second hoop layers having a thickness that gradually decreases in a direction from the cylinder part to a respective one of the side parts.

2. The pressure vessel of claim 1, wherein the first hoop layer surrounds a central region of the cylinder part and the second hoop layers surround two edge regions of the cylinder part with the first hoop layer interposed therebetween.

3. The pressure vessel of claim 2, wherein a center of the first hoop layer corresponds to a center of the cylinder part, a length of the first hoop layer is 40% to 60% of a length of the cylinder part, and a length of each of the second hoop layers is 20% to 30% of a length of the cylinder part.

4. The pressure vessel of claim 3, wherein the thickness of each of the second hoop layers linearly decreases in the direction from the cylinder part to the respective one of the side parts.

5. The pressure vessel of claim 4, wherein each of the second hoop layers is provided to have a right-angled triangular cross section having a height H corresponding to a thickness of the first hoop layer, and an angle θ between a hypotenuse and a base line of the right-angled triangular cross section satisfies tan θ=H/L2, where H is the height of the right-angled triangular cross section, and L2 is the length of the respective second hoop layer corresponding to the base line of the right-angled triangular cross section.

6. The pressure vessel of claim 1, wherein the carbon fiber layer comprises a first helical layer surrounding an outer surface of the liner, and the first hoop layer and the second hoop layers are formed on an outer surface of the first helical layer.

7. The pressure vessel of claim 6, wherein the first helical layer has a thickness equal to or smaller than 5% of a whole thickness of the carbon fiber layer.

8. A pressure vessel comprising:
a liner comprising a cylinder part and dome-shaped side parts at both ends of the cylinder part; and
a carbon fiber layer comprising:
a first hoop layer surrounding a part of an outer circumferential surface of the cylinder part;
second hoop layers surrounding remaining parts of the outer circumferential surface of the cylinder part, each of the second hoop layers having a thickness that gradually decreases in a direction from the cylinder part to a respective one of the side parts; and
a second helical layer surrounding an outer surface of the first hoop layer, outer surfaces of the second hoop layers, and outer surfaces of the side parts.

9. The pressure vessel of claim 8, wherein the carbon fiber layer comprises a third hoop layer covering an outer surface of the second helical layer.

10. The pressure vessel of claim 9, wherein the third hoop layer has a smaller thickness than the first hoop layer.

11. The pressure vessel of claim 10, wherein the first hoop layer has a thickness equal to or larger than 90% of a preset reference hoop layer thickness.

12. The pressure vessel of claim 10, wherein the third hoop layer has a thickness less than 10% of a preset reference hoop layer thickness.

13. A method of manufacturing a pressure vessel, the method comprising:
providing a liner comprising a cylinder part and dome-shaped side parts provided at both ends of the cylinder part;
forming a first hoop layer surrounding a part of an outer circumferential surface of the cylinder part; and
forming second hoop layers surrounding remaining parts of the outer circumferential surface of the cylinder part and each having a thickness that gradually decreases in a direction from the cylinder part to the respective side part.

14. The method of claim 13, wherein:
the first hoop layer surrounds a central region of the cylinder part; and
the second hoop layers to surround two edge regions of the cylinder part with the first hoop layer interposed therebetween.

15. The method of claim 14, wherein a center of the first hoop layer corresponds to a center of the cylinder part, a length of the first hoop layer is 40% to 60% of a length of the cylinder part, and a length of each of the second hoop layers is 20% to 30% of a length of the cylinder part.

16. The method of claim 15, wherein each of the second hoop layers has a right-angled triangular cross section having a height H corresponding to a thickness of the first hoop layer, and an angle θ between a hypotenuse and a base line of the right-angled triangular cross section satisfies tan θ=H/L2, where H is the height of the right-angled triangular cross section, and L2 is the length of the respective second hoop layer corresponding to the base line of the right-angled triangular cross section.

17. The method of claim 13, further comprising forming a first helical layer surrounding an outer surface of the liner, wherein the first hoop layer and the second hoop layers are provided on an outer surface of the first helical layer.

18. The method of claim 13, further comprising forming a second helical layer surrounding an outer surface of the first hoop layer, outer surfaces of the second hoop layers, and outer surfaces of the side parts.

19. The method of claim 18, further comprising forming a third hoop layer covering an outer surface of the second helical layer.

20. The method of claim 19, wherein the third hoop layer has a smaller thickness than the first hoop layer, the first hoop layer has a thickness equal to or larger than 90% of a preset reference hoop layer thickness, and the third hoop layer has a thickness less than 10% of the preset reference hoop layer thickness.
